(19) United States
(12) Patent Application Publication
(10) Pub. No.: US 2017/0236543 A1
(43) Pub. Date: Aug. 17, 2017

(54) OPTICAL INFORMATION RECORDING/REPRODUCING DEVICE AND HOLOGRAPHIC RECORDING/REPRODUCING METHOD

(71) Applicant: Hitachi-LG Data Storage, Inc., Tokyo (JP)

(72) Inventor: Kazuyoshi YAMAZAKI, Tokyo (JP)

(21) Appl. No.: 15/401,489

(22) Filed: Jan. 9, 2017

(30) Foreign Application Priority Data
Feb. 17, 2016 (JP) 2016-027531

(51) Int. Cl. G11B 7/007; G11B 7/1395; G11B 7/08; G11B 7/13; G03H 1/26; G11B 7/0065

(52) U.S. Cl. CPC G11B 7/00772; G03H 1/265; G11B 7/0065; G11B 7/083; G11B 7/13; G11B 7/1395

(57) ABSTRACT

An optical information recording/reproducing device which reproduces information from an optical information storage medium in which an interference pattern between a signal beam and a reference beam is recorded as page data includes a controller, a laser light source, a split part, an angle variable part, an optical part, a first light detector, and a second light detector, and the controller controls the angle variable part based on a control signal generated from a first signal detected by the first light detector and a second signal detected by the second light detector.

### BACKGROUND

Technical Field

The present invention relates to a hologram device and a holographic reproducing method for reproducing information from an optical information storage medium with a hologram technology.

Related Art

Recently, there has been proposed a two-beam angle multiplexing method as a hologram technology capable of recoding and reproducing large amount of data at high speed. A holographic memory is a system in which a signal beam is caused to interfere with a reference beam and an interference pattern thereof is recorded in an optical information storage medium as a hologram. In the two-beam angle multiplexing method, the hologram is multiplexedly recorded by changing angles of incidence of the reference beam on the same position in the optical information storage medium. Then, to reproduce the information recorded in the optical information storage medium, the reference beam is caused to enter the optical information storage medium at the same angle of incidence at the time of the recording, and a recovered beam diffracted from the hologram is detected by an imaging element.

In this method, since multiplexing recording is performed by slightly changing angles of incidence of the reference beam on the optical information storage medium in order to achieve a large capacity, a margin of an angular shift of the reference beam is extremely small, and it is needed to accurately control the angle of incidence on the optical information storage medium at the time of reproducing. To solve this problem, the technology disclosed in US 2009/0207710 A controls an angle of incidence of a reference beam on a disc by detecting a signal beam by an imaging element, calculating an SNR (signal-to-noise ratio) for each recoded angle, and estimating a next angle of incidence on the disc from the calculated value in order to search for the angle of incidence of the reference beam.

### SUMMARY

### Technical Problem

There are two problems in the technology disclosed in US 2009/0207710 A, while an angle of incidence of a reference beam is searchable. The first problem is that it is difficult to perform reproducing at high speed because a control signal (hereinafter, referred to as an angular error signal) for an angle of incidence of the reference beam is generated after a recovered signal is detected by an imaging element and an SNR is calculated. The second problem is that a high-quality recovered signal cannot be obtained because the angle of incidence is set to an angle slightly shifted from a relative angle at which a recovered signal is to be optimal in order to generate an angular error signal of the reference beam.

Thus, the purpose of the present invention is to provide a hologram device and a holographic reproducing method which are capable of performing reproducing at high speed and detecting an angular error signal to obtain a high-quality recovered signal in a two-beam angle multiplexing method.

### Solution to Problem

The above purpose can be achieved by the invention described in claims.

### Advantageous Effects of Invention

According to the present invention, it is possible to provide a hologram device and a holographic reproducing method which are capable of performing reproducing at high speed and detecting an angular error signal to obtain a high-quality recovered signal.

### BRIEF DESCRIPTION OF DRAWINGS

FIG. 1 is a block diagram illustrating a holographic recording/reproducing device in a first embodiment;

FIG. 2 is a diagram illustrating an optical system in the first embodiment;

FIG. 3 is a diagram explaining a method for detecting an angular error signal in the first embodiment;

FIG. 4 is a diagram explaining the method for detecting the angular error signal in the first embodiment;

FIG. 5 is a flowchart explaining a control procedure in a second embodiment;

FIG. 6 is a diagram explaining a method for detecting an angular error signal in the second embodiment;

FIG. 7 is a diagram illustrating an optical system in a third embodiment;

FIG. 8 is a diagram explaining a method for detecting an angular error signal in the third embodiment;

FIG. 9 is a flowchart explaining a control procedure in the third embodiment; and

FIG. 10 is a diagram explaining a correction effect in the third embodiment.

### DETAILED DESCRIPTION

### First Embodiment

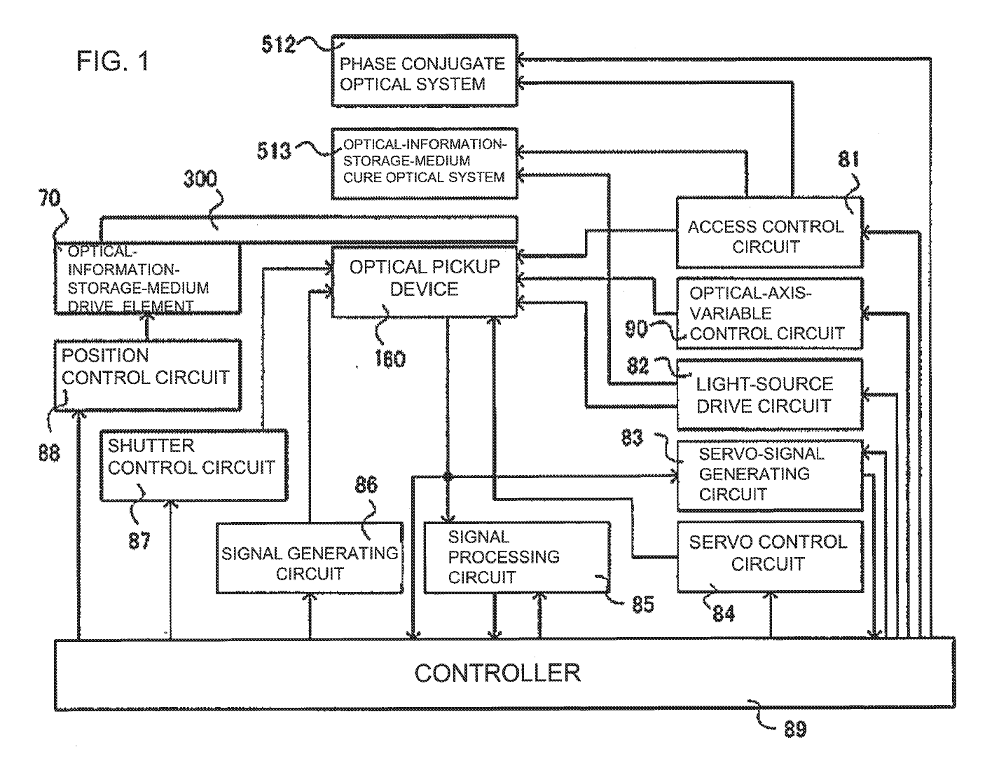

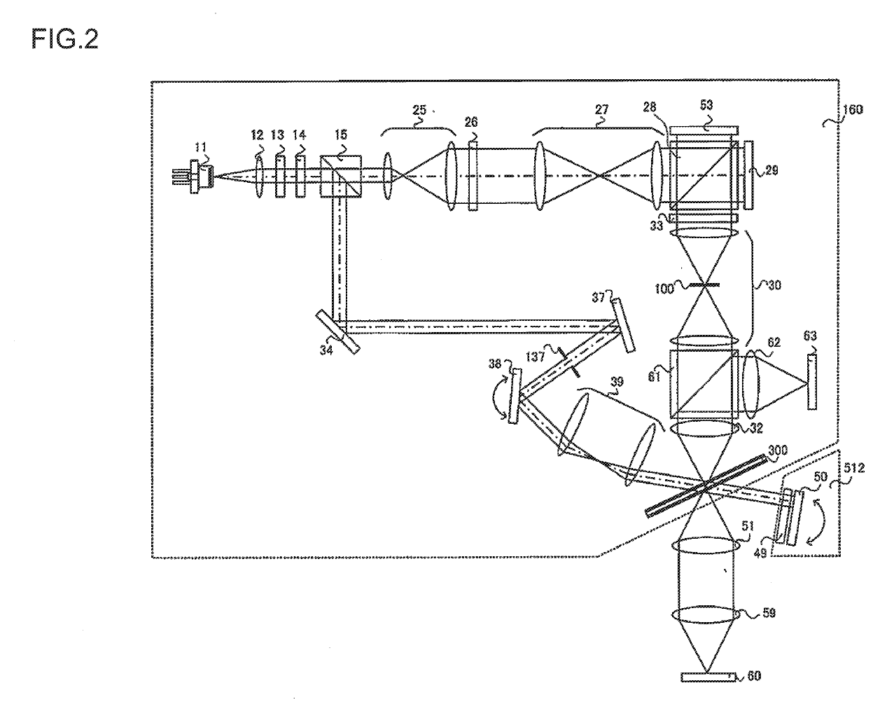

FIG. 1 illustrates an entire configuration of a holographic recording/reproducing device according to a first embodiment of the present invention. The holographic recording/reproducing device includes an optical pickup device 160 having a configuration illustrated in, for example, FIG. 2, a phase conjugate optical system 512, an optical-information-storage-medium cure optical system 513, and an optical-information-storage-medium drive element 70.

The optical pickup device 160 emits a signal beam and a reference beam to an optical information storage medium 300 and records digital information using a hologram. At this time, an information signal to be recorded is sent to a spatial light modulator in the optical pickup device 160 through a signal generating circuit 86 by a controller 89, and the signal beam is modulated by the spatial light modulator. In order to reproduce the information recorded in the optical information storage medium 300, a phase conjugate beam of a reference beam emitted from the optical pickup device 160 is generated by the phase conjugate optical system 512. Here, the phase conjugate beam is a light wave travelling in a reverse direction while maintaining the same wavefront as an input beam.

A recovered beam to be reproduced with the phase conjugate beam is detected by an imaging element 53 in the optical pickup device 160, and a signal is reproduced by a signal processing circuit 85. The exposure time of the optical information storage medium 300 exposed to the reference beam and the signal beam can be adjusted by controlling an opening/closing time of a shutter 13 in the optical pickup device 160 by the controller 89 through a shutter control circuit 87. The optical-information-storage-medium cure optical system 513 generates a light beam used for pre-curing and post-curing the optical information storage medium 300. Here, the pre-curing is pre-processing in which a desired position in the optical information storage medium 300 is exposed to a predetermined light beam before the desired position is exposed to the signal beam and the reference beam when information is recorded at the desired position. The post-curing is post-processing in which the desired position in the optical information storage medium 300 is exposed to a predetermined light beam so that further information is not added after the information is recorded at the desired position.

A predetermined light-source drive current is supplied to the light sources in the optical pickup device 160 and the optical-information-storage-medium cure optical system 513 from a light-source drive circuit 82, and each light source emits a light beam at a predetermined amount of light.

Note that, in the optical pickup device 160, the phase conjugate optical system 512, and the optical-information-storage-medium cure optical system 513, some or all of optical system configurations may be simplified by being integrated into one.

FIG. 2 illustrates an optical system of the optical pickup device 160 and the phase conjugate optical system 512 in the holographic recording/reproducing device of the present embodiment using a two-beam angle multiplexing method. With reference to FIG. 2, a recording method and a reproducing method of the present embodiment are described. First, the recoding method of the present embodiment is described.

A light beam emitted from a light source 11 transmits a collimator lens 12 to change the diameter to a desired beam diameter, passes through the shutter 13, and enters a polarized-beam variable element 14. Then, the light beam is converted into a polarized beam including a polarization component in a horizontal direction and a polarization component in a perpendicular direction by the polarized-beam variable element 14. The polarized-beam variable element 14 converts the light beam into a predetermined polarized beam according to recording or reproducing. In the present embodiment, the polarized-beam variable element 14 converts the light beam into a polarized beam including a polarization component in a horizontal direction and a polarization component in a perpendicular direction at the time of recording, and into a polarized beam in a perpendicular direction at the time of reproducing. For example, this can be achieved by rotating an HWP (half-wave plate) in an optical axis direction according to recording or reproducing, or controlling the voltage of a liquid crystal.

The light beam emitted from the polarized-beam variable element 14 enters a PBS (Polarizing Beam Splitter) prism 15, but the polarization component in the horizontal direction transmits the PBS prism 15, and the polarization component in the perpendicular direction is reflected by the PBS prism 15. Here, the light beam having transmitted the PBS prism 15 is referred to as a signal beam, and the light beam reflected by the PBS prism 15 is referred to as a reference beam. The diameter of the signal beam having transmitted the PBS prism 15 is changed to a desired beam diameter by a beam expander 25. The signal beam having transmitted the beam expander 25 enters a spatial light modulator 29 through a phase mask 26, a relay lens 27, and a PBS prism 28. The spatial light modulator 29 is an optical element which adds two-dimensional data to the signal beam.

Then, the signal beam to which information is added by the spatial light modulator 29 is reflected by the PBS prism 28 and enters an aperture 100 through a polarized-beam variable element 33 and a relay lens 30. The polarized-beam variable element 33 emits the polarized beam in the perpendicular direction as it is at the time of recording, or converts the polarized beam in the horizontal direction into a polarized beam in the perpendicular direction at the time of reproducing. The aperture 100 is arranged to remove a high-frequency component added by the spatial light modulator 29 to the signal beam to enhance the recording density of the optical storage medium. The signal beam emitted from the aperture 100 is condensed in the optical information storage medium 300 through a PBS prism 61 and an objective lens 32. Note that, the PBS prism 61 is arranged so as to reflect the light beam in the perpendicular direction with respect to a plane of paper.

On the other hand, the reference beam reflected by the PBS prism 15 enters the optical information storage medium 300 through a mirror 34, a mirror 37, an aperture 137, a galvano mirror 38, and a scanner lens 39. Here, the galvano mirror 38 changes an angle of incidence of the reference beam on the optical information storage medium 300 by changing the angle of the mirror itself. The scanner lens 39 causes the reference beam, which has been reflected by the galvano mirror 38 and has a predetermined angle, to enter substantially the same position in the optical information storage medium 300 at a predetermined angle.

At this time, the signal beam and the reference beam enter the optical information storage medium 300 so as to be superposed on each other. Accordingly, an interference pattern is formed in the optical information storage medium, and the interference pattern is recoded in the recording material in the optical information storage medium 300 as a hologram.

Then, after the information is recoded in the optical information storage medium 300, the shutter 13 is closed, and information to be recorded next is displayed by the spatial light modulator 29. At the same time, the galvano mirror 38 slightly rotates, and the angle of incidence of the reference beam on the optical information storage medium 300 is changed. Thereafter, when the shutter 13 is opened, the next information is recoded at substantially the same position in the optical information storage medium 300. By repeating this operation, angular multiplexing recording is performed. Then, when the number of recording reaches a predetermined multiplexing number, the position of the optical information storage medium 300 is moved, and further recording is performed. Here, each piece of information recorded at substantially the same position by angular multiplexing is referred to as a page, and the recorded area in the optical information storage medium 300 is referred to as a book.

Next, a reproducing method is described. The light beam emitted from the light source 11 transmits the collimator lens 12 to change the diameter to a desired beam diameter, passes through the shutter 13, and enters the polarized-beam variable element 14. Then, the light beam is converted into a polarized beam in a perpendicular direction by the polarized-beam variable element 14, and is reflected by the PBS prism 15. The reference beam reflected by the PBS prism 15 enters the optical information storage medium 300 through the mirror 34, the mirror 37, the aperture 137, the galvano mirror 38, and the scanner lens 39. Here, when the reference beam enters the optical information storage medium 300, a diffracted beam according to the angle of incidence is generated in the direction of a lens 51. The diffracted beam enters a light receiving part of a light detector 60 through a detection lens 59.

On the other hand, the reference beam having transmitted the optical information storage medium 300 enters a galvano mirror 50 through a wave plate 49. The galvano mirror 50 is controlled by the controller 89 so that an optical axis of a light beam to be reflected is shifted by an angle φ with respect to an incident light beam, and the reflected reference beam enters the optical information storage medium 300 through the wave plate 49 again. At this time, since the reference beam has transmitted the wave plate 49 twice, the polarized beam of the reference beam has the polarization component in the horizontal direction and the polarization component in the perpendicular direction. Then, when the reference beam enters a predetermined book in the optical information storage medium 300, a recovered beam is generated from the hologram in the optical information storage medium 300 as a diffracted beam in the direction of the objective lens 32.

The recovered beam enters the PBS prism 61 through the objective lens 32. Here, since the recovered beam has the same polarization components as the polarized beam of the reference beam, the polarization component in the perpendicular direction transmits the PBS prism 61, and the polarization component in the horizontal direction is reflected by the PBS prism 61. The recovered beam reflected by the PBS prism 61 enters a light receiving part of a light detector 63 through a detection lens 62.

On the other hand, the recovered beam having transmitted the PBS prism 61 enters the imaging element 53 through the relay lens 30, the aperture 100, the polarized-beam variable element 33, and the PBS prism 28. Note that, the polarized-beam variable element 33 converts the incident polarized beam in the perpendicular direction into a polarized beam in the horizontal direction. Then, reproduction image data is generated based on the recovered beam having entered the imaging element 53.

Then, the galvano mirror 38 slightly rotates, and the angle of incidence of the reference beam on the optical information storage medium 300 is changed. Accordingly, image data in a different page in the same book is reproduced. Then, when image data in a predetermined number of pages is reproduced, the position of the optical information storage medium 300 is moved, and the next book is reproduced.

Here, when the signal obtained by the light detector 60 is S1 and the signal obtained by the light detector 63 is S2, an angular error signal AES can be expressed as follows:

AES=k×S1−S2

where each of the signal S1 and the signal S2 is a sum signal of the detected total amount of each diffracted beam, and k is an amplification factor of the signal S2.

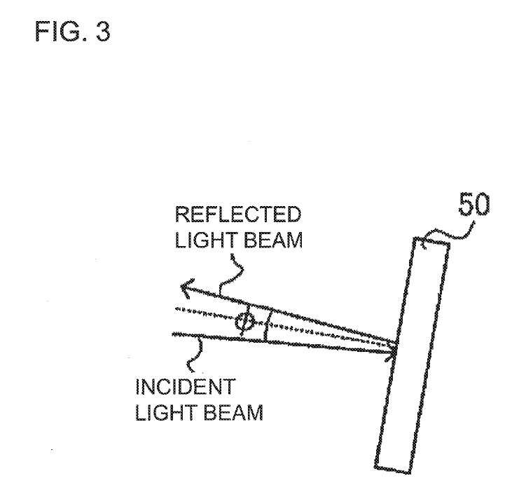

A method for detecting and controlling the angular error signal is described below. FIG. 3 illustrates a relation between the incident light beam and the reflected light beam of the reference beam on/by the galvano mirror 50. As described above, the galvano mirror 50 is controlled by the controller 89 so that the angle of incidence of the incident light beam is to be substantially φ/2. Thus, the optical axis of a light beam to be emitted is shifted by the angle φ with respect to the incident light beam.

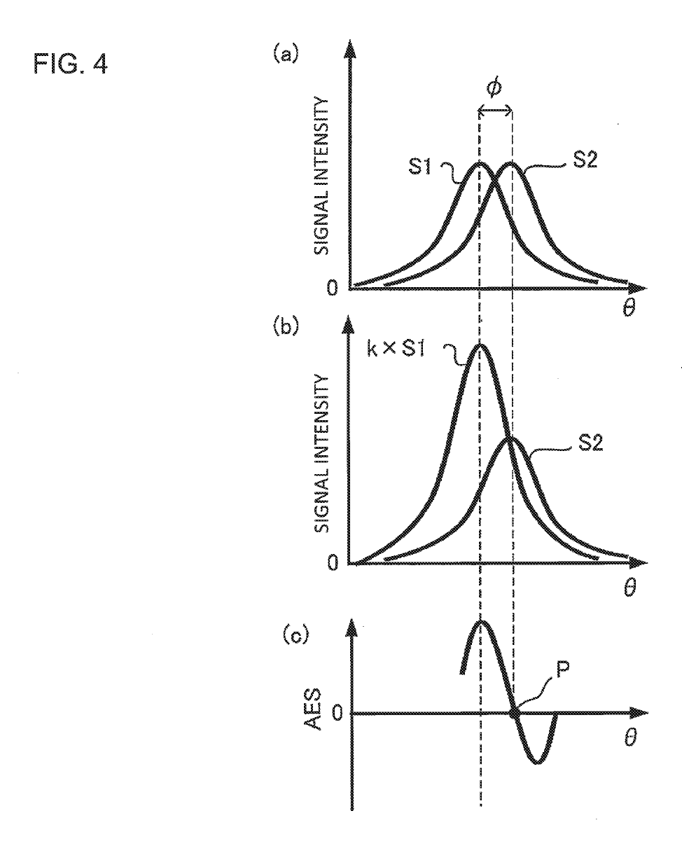

FIG. 4 illustrates relations among a rotation angle θ of the galvano mirror 38, the signal S1, the signal S2, and the angular error signal. A graph (a) in FIG. 4 illustrates a relation between the signal S1 and the signal S2. Here, it is assumed that the intensities of the signal S1 and the signal S2 are the same. This can be achieved by setting the light receiving sensitivity of the light detector 60 and the light detector 63 to a desired value. Since the angle of the reference beam is shifted by the angle φ by the galvano mirror 50 in the present embodiment, the angles at which the two signals have the maximum intensities are shifted by the angle φ as illustrated in the graph (a) in FIG. 4. Note that, the optimal angle of a recovered signal coincides with the maximum angle of the signal S2. Thus, in view of reproduction performance, it is desired to control the angle of the galvano mirror 38 so that the signal S2 has the maximum intensity.

A graph (b) in FIG. 4 illustrates the signal S1 multiplied by k and the signal S2. A graph (c) in FIG. 4 illustrates the angular error signal. In the graph (b) in FIG. 4, the signal S2 is multiplied by k so that the signal S2 intersects with the signal S1 at the angle of the signal S2 having the maximum intensity. Accordingly, an angle P at which the angular error signal in the graph (c) in FIG. 4 is to be zero can be assumed to be the optimal angle of the recovered signal. Thus, by controlling the galvano mirror 38 so that the angular error signal is to be zero, it is possible to stably perform reproducing. Furthermore, in comparison with the method for performing control based on an image signal from an imaging element, the light detector 60 and the light detector 63 which detect only an amount of light can be driven at a high frequency and easily controlled at high speed.

As described above, by shifting, by the angle φ, the angle of the optical axis of the reference beam entering the optical information storage medium 300 in the reciprocating path and controlling the galvano mirror 38 using the signal having the difference between the amounts of the two diffracted beams obtained by the reciprocating, it is possible to stably perform reproducing at high speed.

### Second Embodiment

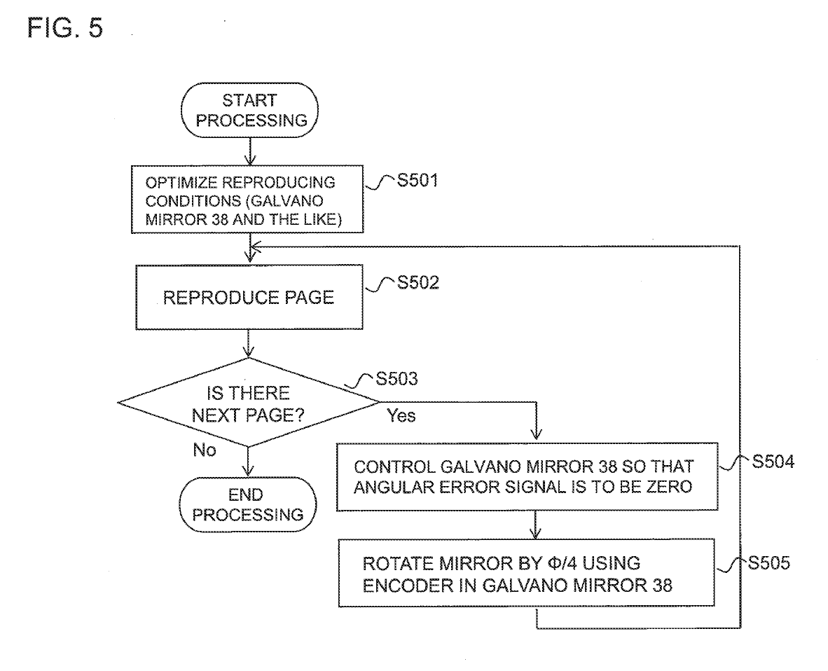

FIG. 5 illustrates a control procedure of a galvano mirror according to a second embodiment of the present invention. The difference from the first embodiment is the method for generating and controlling an angular error signal. Since the other points other than the method are similar to those of the first embodiment, the different point from the first embodiment is described in the present embodiment.

FIG. 5 illustrates a control procedure of a galvano mirror 38 when reproducing a book. First, in the present embodiment, a signal S1 and a signal S2 are detected similarly to the first embodiment, and an angular error signal AES is generated with the following expression:

AES=S1−S2

where each of the signal S1 and the signal S2 is a sum signal of the detected total amount of each diffracted beam.

First, the galvano mirror 38 and the like are adjusted by performing optimization to obtain predetermined reproduction performance (S501). Thereafter, a first page is reproduced (S502). Then, it is determined whether there is a next page (S503), and when there is a next page, the galvano mirror 38 is controlled so that the angular error signal to be zero (S504). Thereafter, the galvano mirror 38 is rotated by φ/4 using an encoder in the galvano mirror 38 to tilt an angle of a reference beam by φ/2 (S505). Then, the page is reproduced (S502). Thereafter, it is determined whether there is a next page (S503), and when there is a next page, the next page is reproduced using the angular error signal and the encoder in the galvano mirror 38. Alternatively, when there is no next page, the reproduction of the book is terminated.

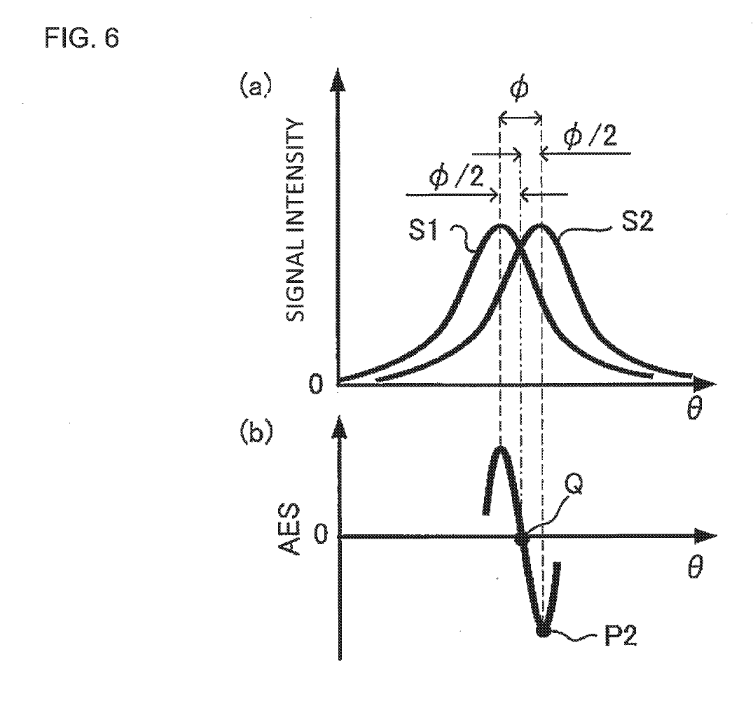

Here, the reason that the reference beam is tilted by φ/2 using the galvano mirror 38 is described. FIG. 6 illustrates relations among a rotation angle θ of the galvano mirror 38, the signal S1, the signal S2, and the angular error signal. A graph (a) in FIG. 6 illustrates a relation between the signal S1 and the signal S2. A graph (b) in FIG. 6 illustrates the angular error signal. Here, as illustrated in the graph (a) in FIG. 6, when the intensities of the signal S1 and the signal S2 are to be substantially the same, the two signals intersect with each other at the angle between the two angles of the two signals each having the maximum intensity. Thus, the angle shifted by substantially φ/2 from an angle Q at which the angular error signal is to be zero is the optimal angle of a recovered signal.

In the present embodiment, the reference beam is tilted by φ/2 using the encoder in the galvano mirror to optimally perform reproducing. With this processing, it is possible to stably perform reproducing similarly to the first embodiment. Furthermore, in comparison with the method for performing control based on an image signal from an imaging element, the light detectors 60 and 63 which detect only an amount of light can be driven at a high frequency and easily controlled at high speed.

As described above, by shifting, by the angle φ, the angle of the optical axis of the reference beam entering an optical information storage medium 300 in the reciprocating path and controlling the galvano mirror 38 using the signal having the difference between the amounts of the two diffracted beams obtained by the reciprocating, it is possible to stably perform reproducing at high speed.

The following modifications can be made in the first and second embodiments. In the first and second embodiments, an angular error signal in an angular multiplexing direction is generated, but is not limited to this, and an angular shift in the perpendicular direction may be generated as the angular error signal. In this case, an angle variable element in the direction is added.

Furthermore, when the optical information storage medium 300 having a high recording density (a distance between books is small) is reproduced, a diffracted beam from an adjacent recording area can enter a light detector for an angular error signal. In order to avoid this, a spatial filter may be arranged in front of each light detector (a light detector 60 and a light detector 63). A detection optical system (a PBS prism 61 and a detection lens 62) of the light detector 63 may be arranged between an aperture 100 and an imaging element 53.

Moreover, the signal S2 is detected by the light detector 63 in the present embodiment, but may be detected by, for example, the imaging element 53. In this case, the reproduction speed is slower than that in the configuration in FIG. 2, but the number of parts can be reduced and which is advantageous in downsizing and cost reduction. The accuracy is the same level as that in the present embodiment.

Furthermore, the galvano mirror 38 is controlled by the encoder in the galvano mirror in the present embodiment, but is not limited to this, and a sensor such as an external autocollimator may be used.

### Third Embodiment

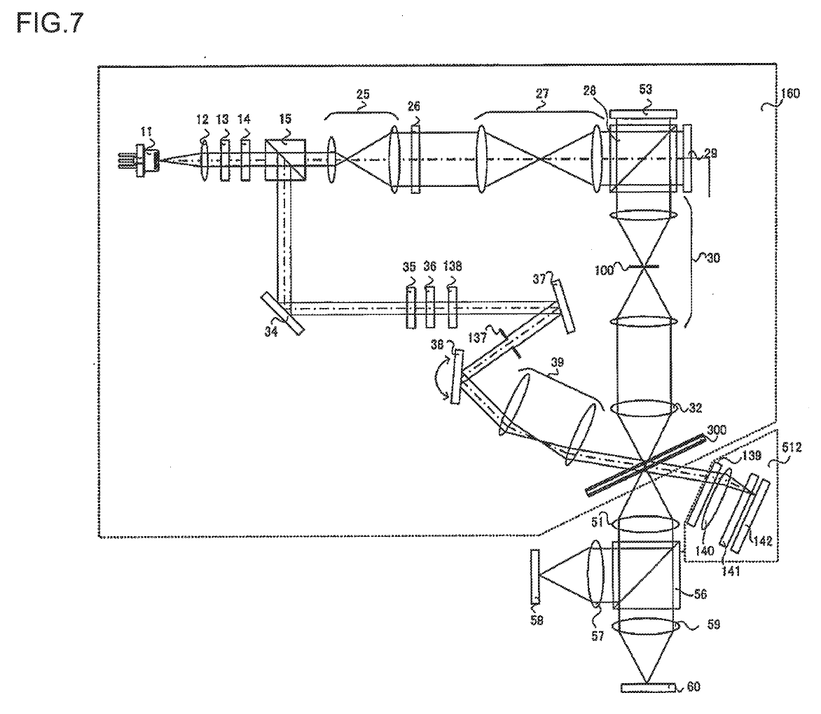

FIG. 7 illustrates an optical system of an optical pickup device 160 and a phase conjugate optical system 512 in a holographic recording/reproducing device according to a third embodiment of the present invention using a two-beam angle multiplexing method. In the present embodiment, the technology disclosed in PCT/JP2013/060424 is used to control an angle in a multiplexing direction, and the technology described in the first and second embodiments is used to control an angle in a direction perpendicular to the multiplexing direction.

With reference to FIG. 7, a recording method and a reproducing method of the present embodiment are described. First, the recoding method of the present embodiment is described.

A light beam emitted from a light source 11 transmits a collimator lens 12 to change the diameter to a desired beam diameter, passes through a shutter 13, and enters a polarized-beam variable element 14. Then, the light beam is converted into a polarized beam including a polarization component in a horizontal direction and a polarization component in a perpendicular direction by the polarized-beam variable element 14.

The light beam emitted from the polarized-beam variable element 14 enters a PBS prism 15, but the polarization component in the horizontal direction transmits the PBS prism 15, and the polarization component in the perpendicular direction is reflected by the PBS prism 15. A signal beam having transmitted the PBS prism 15 is condensed in an optical information storage medium 300 through a beam expander 25, a phase mask 26, a relay lens 27, a PBS prism 28, a spatial light modulator 29, the PBS prism 28, a relay lens 30, an aperture 100, and an objective lens 32.

On the other hand, a reference beam reflected by the PBS prism 15 enters a polarized-beam variable element 35 through a mirror 34. The polarized-beam variable element 35 emits the incident reference beam as a polarized beam in the perpendicular direction at the time of recording, or converts the incident reference beam into a polarization component including a polarized beam in the horizontal direction and a polarized beam in the perpendicular direction at the time of reproducing. Then, the reference beam having transmitted the polarized-beam variable element 35 enters a Wollaston prism 36. The Wollaston prism 36 is an optical element which tilts an optical axis of a predetermined polarized beam. In the present embodiment, the polarized beam in the perpendicular direction is emitted as it is and the optical axis of the polarized beam in the horizontal direction is tilted in the multiplexing direction.

The reference beam having transmitted the Wollaston prism 36 enters the optical information storage medium 300 through a mirror 37, an aperture 137, a galvano mirror 38, and a scanner lens 39. At this time, the signal beam and the reference beam enter the optical information storage medium 300 so as to be superposed on each other. Accordingly, an interference pattern is formed in the optical information storage medium 300, and the interference pattern is recorded in the recording material in the optical information storage medium 300 as a hologram.

Next, the reproducing method is described. The light beam emitted from the light source 11 transmits the collimator lens 12 to change the diameter to a desired beam diameter, passes through the shutter 13, and enters the polarized-beam variable element 14. Then, the light beam is converted into a polarized beam in the perpendicular direction by the polarized-beam variable element 14, and is reflected by the PBS prism 15. The reference beam reflected by the PBS prism 15 enters the polarized-beam variable element 35 through the mirror 34. The polarized-beam variable element 35 converts the incident polarized beam in the perpendicular direction into a polarization component including a polarized beam in the horizontal direction and a polarized beam in the perpendicular direction. Then, the reference beam having transmitted the polarized-beam variable element 35 enters the Wollaston prism 36. The Wollaston prism 36 in the present embodiment is an optical element which tilts the optical axis of the polarized beam in the horizontal direction by an angle γ in the multiplexing direction. Thus, the optical axis of the polarized beam in the perpendicular direction emitted from the Wollaston prism 36 is shifted from that of the reference beam of the polarized beam in the horizontal direction by the angle γ. In the present embodiment, the light beam of the polarized beam in the perpendicular direction is referred to as a reference beam, and the light beam of the polarized beam in the horizontal direction is referred to as a control beam.

The two light beams having transmitted the Wollaston prism 36 enter an angle variable element 138. The angle correction element 138 changes an angle in the direction perpendicular to the multiplexing direction. This can be implemented by, for example, rotating a wedge prism in the perpendicular direction with respect to an incident optical axis. The two light beams having transmitted the angle correction element 138 enter the optical information storage medium 300 through the mirror 37, the aperture 137, the galvano mirror 38, and the scanner lens 39. Here, when the light beams enter the optical information storage medium 300, diffracted beams according to the angles of incidence are generated in the direction of a lens 51. At this time, since the diffracted beams generated in the optical information storage medium 300 are the same polarized beams as the incident polarized beams of the light beams, the diffracted beam generated from the reference beam is reflected by a PBS prism 56 and enters a light receiving part of a light detector 58 through a detection lens 57, and the diffracted beam generated from the control beam transmits the PBS prism 56 and enters a light receiving part of a light detector 60 through a detection lens 59.

Here, when the signal obtained by the light detector 58 is S3 and the signal obtained by the light detector 60 is S4, an angular error signal AES1 in the multiplexing direction is expressed as follows:

AES1=S3−S4

where each of the signal S3 and the signal S4 is a sum signal of the detected total amount of each diffracted beam.

On the other hand, the two light beams having transmitted the optical information storage medium 300 enter a Wollaston prism 139. The Wollaston prism 139 in the present embodiment is an optical element which tilts a polarization component in the horizontal direction in a direction perpendicular to the multiplexing direction. Then, the two light beams having transmitted the Wollaston prism 139 enter a mirror 142 through a lens 140 and a quarter wave plate 141. The mirror 142 reflects the two light beams while the two light beams are substantially converging. Then, the two light beams reflected by the mirror 142 enter the optical information storage medium 300 again through the quarter wave plate 141, the lens 140, and the Wollaston prism 139. Here, since the light beams have transmitted the quarter wave plate 141 twice before and after the reflection by the mirror 142, the reference beam is converted into a polarized beam in the horizontal direction, and the control beam is converted into a polarized beam in the perpendicular direction.

Here, when the light beams enter a predetermined book in the optical information storage medium 300, recovered beams are generated in the direction of the objective lens 32 from the hologram in the optical information storage medium 300 as diffracted beams.

The recovered beams enter the PBS prism 28 through the objective lens 32, the relay lens 30, and the aperture 100. Here, only the recovered beam diffracted from the reference beam of the polarized beam in the horizontal direction transmits the PBS prism 28 and enters an imaging element 53. Then, reproduction image data is generated based on the recovered beam having entered the imaging element 53. Furthermore, when the signal obtained by the imaging element 53 is S5 and the signal obtained by the light detector 58 of a detector 58 is S3, an angular error signal AES2 in the direction perpendicular to the multiplexing direction can be expressed as follows:

AES2=S3−S5

where the signal S5 is a sum signal of all of detected pixels.

A detecting method and a control method for an angular error signal are described below. Here, the angular error signal in the direction perpendicular to the multiplexing direction which is a feature of the present invention is described. The angular error signal in the multiplexing direction is similar to that in PCT/JP2013/060424.

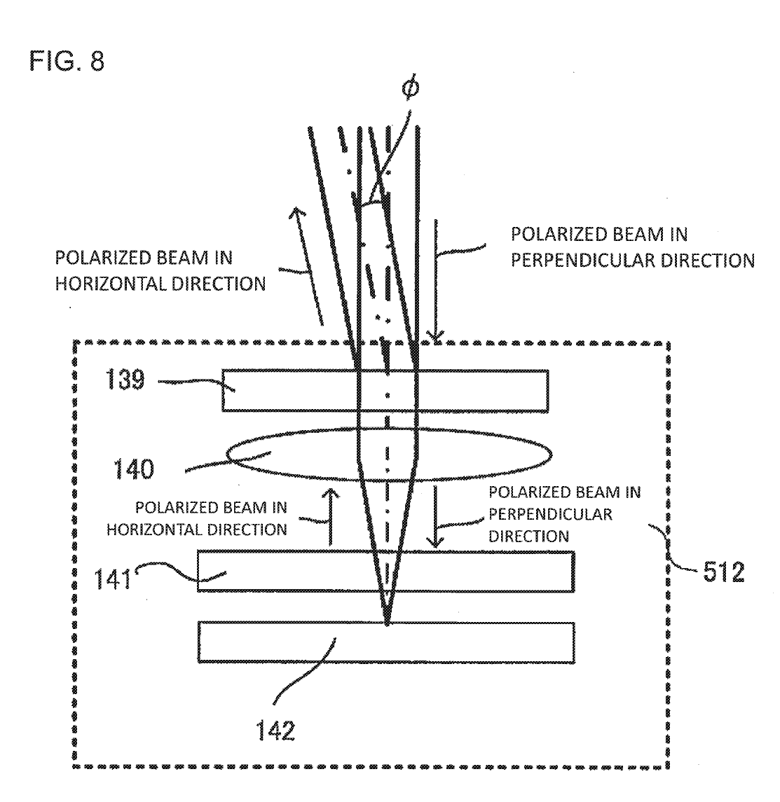

FIG. 8 illustrates that the phase conjugate optical system 512 is viewed in a direction perpendicular to a multiplexing direction. Note that, since the light beam detected by the imaging element 53 is, as described above, only the reference beam, the reference beam contributing to the angular error signal in the direction perpendicular to the multiplexing direction is only described in FIG. 8. The reference beam of the polarized beam in the perpendicular direction having transmitted the optical information storage medium 300 enters the Wollaston prism 139 again through the Wollaston prism 139, the lens 140, the quarter wave plate 141, the mirror 142, the quarter wave plate 141, and the lens 140. Here, since the reference beam of the polarized beam in the perpendicular direction has transmitted the quarter wave plate 141 twice, the reference beam is converted into a polarized beam in the horizontal direction. Thus, the optical axis of the reference beam of the polarized beam in the horizontal direction is tilted by the Wollaston prism 139 by an angle φ. As described in the first embodiment, by shifting the angle of the optical axis of the reference beam entering the optical information storage medium 300 in the reciprocating path by the angle φ and calculating the difference between the amounts of the two diffracted beams obtained by the reciprocating, an angular error signal can be generated. At this time, the angle variable element 138 is controlled using this angular error signal. Note that, the following is described using the same control method as that in the first embodiment, but a similar effect can be obtained using the second embodiment.

In the present embodiment, the signal from the imaging element 53 is used to generate the angular error signal, but normally it is unnecessary to move the direction perpendicular to the multiplexing direction at high speed at the time of recording or reproducing, and using the signal from the imaging element 53 rarely causes reduction in speed. Furthermore, the imaging element 53 does not need to consecutively detect a signal and generate an angular error signal, and by comparing the amount of light detected by the imaging element 53 with the amount of light detected by the light detector 58, the angle according to the comparison result may be changed by the angle variable element.

On the other hand, when, for example, the galvano mirror 38 is adjusted while the rotation axis is being shifted, an angular shift in the direction perpendicular to the multiplexing direction can be generated according to the rotation of the galvano mirror 38 (the angle control in the multiplexing direction). In this case, the angle variable element 138 is to be controlled as described below.

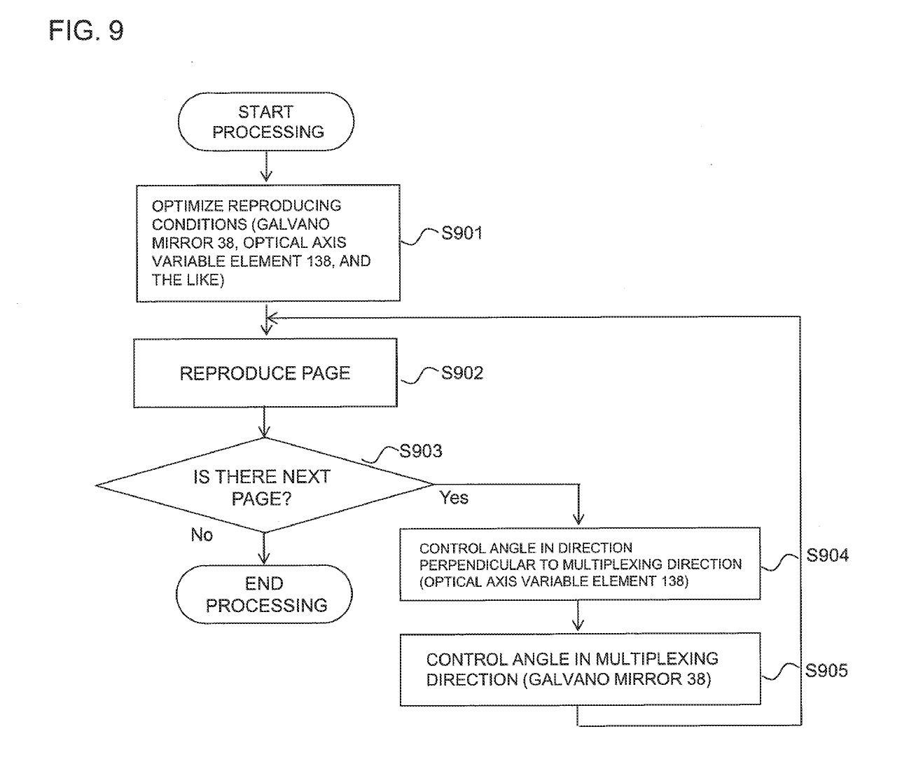

FIG. 9 illustrates a control procedure of the galvano mirror 38 and the optical axis variable element 138 when reproducing a book. First, the galvano mirror 38, the optical axis variable element 138, and the like are adjusted by performing optimization to obtain predetermined reproduction performance (S901). Thereafter, a first page is reproduced (S902). Then, it is determined whether there is a next page (S903), and when there is a next page, the angular error signal in the direction perpendicular to the multiplexing direction is detected based on the amount of light at the time of the reproducing, and the optical axis variable element 138 is controlled (S904). Next, the galvano mirror 38 is controlled according the angular error signal in the multiplexing direction (S905), and the page is reproduced (S902). Thereafter, it is determined whether there is a next page (S903), and when there is a next page, the next page is reproduced using the optical axis variable element 138 and the galvano mirror 38. Alternatively, when there is no next page, the reproduction of the book is terminated.

The important point here is that when a next page is reproduced, the angle control in the multiplexing direction is performed after the angle control in the direction perpendicular to the multiplexing direction is performed. An angle margin in the multiplexing direction is extremely small compared to that in the direction perpendicular to the angular multiplexing direction. Thus, if the adjustment is performed in reverse, the angular shift in the multiplexing direction remains. Theoretically, it is desirable that both angles are controlled simultaneously, but if, for example, the rotation axis of the galvano mirror 38 is shifted, driving one affects the other, and it is difficult to control both angles simultaneously. Thus, the control is performed one by one in the present embodiment.

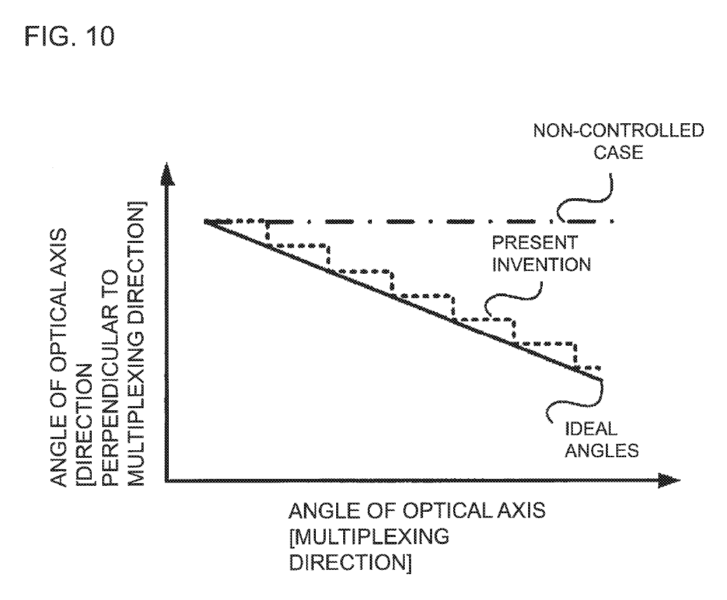

FIG. 10 illustrates angles in the direction perpendicular to the multiplexing direction with respect to the angles in the multiplexing direction when the rotation axis of the galvano mirror 38 is shifted. The solid line indicates ideal angles, the one-dot chain line indicates the case in which the optical axis variable element 138 is not controlled, and the broken line indicates the case of the present invention. The present invention cannot perfectly correct the angle because the angle in the direction perpendicular to the multiplexing direction is shifted according to the angle control in the multiplexing direction, but can obtain a large improved effect compared to the non-controlled case. Furthermore, it is possible to sufficiently control the angle within the angle margin range in the direction perpendicular to the multiplexing direction (within 0.01°). Moreover, since angle change in the perpendicular direction is smaller than that of a page in the multiplexing direction, a sufficient effect can be obtained by performing the angle control in the perpendicular direction (FA5) illustrated in, for example, FIG. 9 once in some pages. Acceleration may be made accordingly. Furthermore, acceleration can be made more easily than a conventional one because an SNR is not calculated.

Then, regarding the angular error signal in the present embodiment, since the shift amount from the ideal angle can be detected according to change in the angle of the optical axis in the multiplexing direction, the optical axis variable element 138 may be controlled by estimating the angle in advance.

The optical axes of the two reference beams are tilted by the tilt of the galvano mirror 50 in the first and second embodiments, but are tilted by the Wollaston prism 139 in the present embodiment. Accordingly, it is possible to accurately generate the angle difference φ between the reference beams entering the optical information storage medium 300.

By performing the above control, it is possible to achieve angle control in a multiplexing direction and in a direction perpendicular to the multiplexing direction accurately at high speed. Accordingly, it is possible to stably perform reproducing at high speed.

In the present embodiment, a shift of the rotation axis of the galvano mirror 38 is described as the factor causing a shift of the angle of the optical axis in the direction perpendicular to the multiplexing direction with respect to the angle of the optical axis in the multiplexing direction, but the factor is not limited to this. For example, the angle of the optical axis in the direction perpendicular to the multiplexing direction is shifted when a hologram is rotated or the like. The angle difference φ between the reference beams is generated using the Wollaston prism 139 in the present embodiment, but is not limited to this, and may be generated using, for example, a polarized-beam diffraction grating or a Rochon prism.

The phase conjugate optical system 512 of the present embodiment has the different configuration from those of the first and second embodiments, but is substantially the same. The difference is only the method for shifting the angle of the reference beam entering the optical information storage medium 300 by the angle φ, and a similar effect can be obtained by replacing the phase conjugate optical system 512 in the present embodiment with those of the first and second embodiments. The method for shifting the angle of the reference beam entering the optical information storage medium 300 by the angle φ is not limited to those in the first to third embodiments. Furthermore, to perform the angle control in the multiplexing direction, the technology in PCT/JP2013/060424 is used in the present embodiment, but is not limited to this. Since it is only required that the angle of the reference beam entering the optical information storage medium 300 is shifted by the angle φ, it is easily to combine the present invention with a method for detecting a control signal for an angle or a position. Moreover, the galvano mirrors 38 and 50 are used as the angle variable element, but the angle variable element is not limited to those, and, for example, an acousto-optical element, Micro Electro Mechanical Systems (MEMS) or the like may be used.

Note that, the present invention is not limited to the above described embodiments, and includes various modifications. For example, the above described embodiments are described in details to easily understand the present invention, and not limited to the configurations having all of the described components. A part of a configuration of one embodiment may be replaced with a part of a configuration of another embodiment, and a configuration of one embodiment may include a configuration of another embodiment. Furthermore, in a part of the configuration of each embodiment, it is possible to add, delete, or replace another configuration. In each embodiment, a holographic recording/reproducing device is described, but a holographic recording device or a holographic reproducing device may be applicable.

What is claimed is:

1. An optical information recording/reproducing device which reproduces information from an optical information storage medium in which an interference pattern between a signal beam and a reference beam is recorded as page data, the optical information recording/reproducing device comprising:
a controller configured to control the entire optical information recording/reproducing device;
a laser light source;
a split part configured to split a light beam emitted from the laser light source into a signal beam and a reference beam;
an angle variable part configured to change an angle of incidence of the reference beam to which the optical information storage medium is to be exposed;
an optical part configured to cause the reference beam having transmitted the optical information storage medium through the angle variable part to enter the optical information storage medium again;
a first light detector configured to detect a first recovered beam generated when the reference beam enters the optical information storage medium through the angle variable part; and
a second light detector configured to detect a second recovered beam generated when the reference beam having transmitted the optical information storage medium enters the optical information storage medium again, wherein
the controller controls the angle variable part based on a control signal generated from a first signal detected by the first light detector and a second signal detected by the second light detector.

2. The optical information recording/reproducing device according to claim 1, wherein a relative angle between a first angle of incidence and a second angle of incidence is substantially φ, where an angle of incidence at which the reference beam enters the optical information storage medium through the angle variable part is the first angle of incidence, and an angle of incidence at which the reference beam having transmitted the optical information storage medium enters the optical information storage medium again is the second angle of incidence.

3. The optical information recording/reproducing device according to claim 1, wherein the control signal is a differential signal between a signal which is the first signal amplified with a predetermined amplification factor and the second signal.

4. The optical information recording/reproducing device according to claim 3, wherein the predetermined amplification factor is a value with which the first signal is amplified such that signal intensities of the first signal and the second signal are to be substantially the same when the angle variable part is controlled such that the second signal has a substantially maximum intensity.

5. The optical information recording/reproducing device according to claim 1, wherein when the controller sets an angle of the reference beam at which the differential signal is to be substantially zero as a control target of the angle variable part, the controller controls the angle variable part so as to be the control target.

6. The optical information recording/reproducing device according to claim 1, wherein
the control signal is a differential signal between the first signal and the second signal, and
when the controller sets an angle of the reference beam shifted by substantially φ/2 from an angle of the reference beam at which the control signal is to be substantially zero as a control target of the angle variable part, the controller controls the angle variable part so as to be the control target.

7. The optical information recording/reproducing device according to claim 6, wherein the controller controls the angle variable part so as to be the control target after the control signal becomes substantially zero.

8. The optical information recording/reproducing device according to claim 1, wherein the first light detector or the second light detector is an imaging part which detects a recovered signal.

9. The optical information recording/reproducing device according to claim 1, wherein the optical part includes an optical element which changes an emitting angle according to a polarized beam, and a wave plate.

10. An optical information recording/reproducing method for reproducing information from an optical information storage medium in which an interference pattern between a signal beam and a reference beam is recorded as page data, the optical information recording/reproducing method comprising:
a step of splitting a light beam emitted from a laser light source into a signal beam and a reference beam;
an angle variable step of changing an angle of incidence of the reference beam to which the optical information storage medium is to be exposed;
a step of causing the reference beam having transmitted the optical information storage medium through the angle variable step to enter the optical information storage medium again;
a first light detection step of detecting a first recovered beam generated when the reference beam enters the optical information storage medium through the angle variable step;
a second light detection step of detecting a second recovered beam generated when the reference beam having transmitted the optical information storage medium enters the optical information storage medium again; and
a step of controlling an angle of incidence of the reference beam based on a control signal generated from a first signal detected in the first light detection step and a second signal detected in the second light detection step, wherein
a relative angle between a first angle of incidence and a second angle of incidence is substantially φ, where an angle of incidence at which the reference beam enters the optical information storage medium through the angle variable step is the first angle of incidence, and an angle of incidence at which the reference beam having transmitted the optical information storage medium enters the optical information storage medium again is the second angle of incidence.

11. The optical information recording/reproducing method according to claim 10, wherein the control signal is a differential signal between a signal which is the first signal amplified with a predetermined amplification factor and the second signal.

12. The optical information recording/reproducing method according to claim 10, wherein
the control signal is a differential signal between the first signal and the second signal, and
an angle of the reference beam shifted by substantially φ/2 from an angle of the reference beam at which the control signal is substantially zero is set as a control target in the angle variable step.

13. An optical information recording/reproducing device which reproduces information from an optical information storage medium in which an interference pattern between a signal beam and a reference beam is recorded as page data, the optical information recording/reproducing device comprising:
a controller configured to control the entire optical information recording/reproducing device;
a laser light source;
a split part configured to split a light beam emitted from the laser light source into a signal beam and a reference beam;
a first angle variable part configured to change an angle of incidence, in an angle-multiplexing direction, of the reference beam to which the optical information storage medium is to be exposed;
a second angle variable part configured to change an angle of incidence in a direction substantially perpendicular to the first angle variable part; and
an imaging part configured to detect a diffracted beam generated from a hologram in the optical information storage medium when the optical information storage medium is exposed to the reference beam, wherein
the controller controls the first angle variable part after controlling the second angle variable part, and
the imaging part detects a recovered signal.
